(19) United States
(12) Patent Application Publication
(10) Pub. No.: US 2026/0264494 A1
(43) Pub. Date: Sep. 10, 2026

(54) BUMPER COVER FOR LIVESTOCK TRAILER AND THE LIKE

(71) Applicant: Hayden PARKS, Wallace, NC (US)

(72) Inventor: Hayden PARKS, Wallace, NC (US)

(21) Appl. No.: 19/071,132

(22) Filed: Mar. 5, 2025

(51) Int. Cl. B60J 11/06; B60R 19/44

(52) U.S. Cl. CPC B60J 11/06; B60R 19/44

(57) ABSTRACT

A flexible sheet of material configured to wrap around and cover a rear bumper of a livestock trailer. The flexible sheet of material is secured by an elastic band secured along at least a portion of a perimeter of the flexible sheet of material. The elastic band is configured to stretch around the bumper to provide a snug and secure fit.

### TECHNICAL FIELD

The disclosure relates to protective covers for livestock trailers and docks for animal confinement buildings, and more particularly to a removable contamination-prevention cover for the rear bumper of a livestock transport trailer or a confinement building unloading dock.

### BACKGROUND INFORMATION

In livestock production and transport, biosecurity is a critical concern. Contamination and disease transmission can occur when livestock trailers travel between multiple facilities, such as farms, processing plants, and auction houses. These trailers frequently back up to loading docks, where their rear bumpers and other contact points may come into direct contact with the dock surfaces. If a loading dock is contaminated with biological material, bacteria, or viruses from one facility, it can be transferred to the trailer and subsequently carried to another location, increasing the risk of cross-contamination between sites.

Many infectious diseases affecting livestock, including swine influenza, porcine reproductive and respiratory syndrome (PRRS), and foot-and-mouth disease, can spread through indirect contact with contaminated surfaces. Even with routine cleaning protocols, trailers can retain organic matter and pathogens in areas that are difficult to disinfect, such as bumpers, undercarriages, and wheel wells. These contaminated surfaces can then transfer pathogens onto the next loading dock the trailer encounters, leading to facility-wide outbreaks that compromise animal health and result in significant economic losses for producers.

Efforts to mitigate contamination risks typically involve strict sanitation protocols, such as washing trailers between loads, applying disinfectants, and limiting access to certain facilities. However, certain areas of the trailer, such as the rear bumper, are particularly prone to contact with contaminated surfaces and may not be adequately sanitized between trips. As a result, additional measures are needed to minimize direct contact between the trailer and loading dock surfaces to prevent the spread of infectious agents.

### SUMMARY

Disclosed is an apparatus for helping to prevent contamination transfer between a livestock trailer bumper and a loading dock. The apparatus comprises of a flexible sheet of material configured to wrap around and cover a rear bumper of a livestock trailer. The flexible sheet of material is secured by an elastic band secured along at least a portion of a perimeter of the flexible sheet of material. The elastic band is configured to stretch around the bumper to provide a snug and secure fit.

In an embodiment, the flexible sheet of material is made from a disposable plastic film selected from the group consisting of high-density polyethylene (HDPE), low-density polyethylene (LDPE), and polypropylene. The flexible sheet of material can be made from a synthetic rubber or elastomeric material, including thermoplastic elastomers (TPE) or silicone. The flexible sheet of material can be made from a coated fabric material, including polyurethane-coated nylon or vinyl-coated polyester. The flexible sheet of material can also be made from nonwoven antimicrobial fabric configured to inhibit bacterial or viral contamination.

In an embodiment, the elastic band is enclosed within a hemmed perimeter of the flexible sheet of material. The elastic band can be heat-sealed, stitched, or adhesively bonded to the flexible sheet of material. Alternatively, a hook-and-loop fasteners positioned on opposing edges of the flexible sheet of material can provide additional securement. Or, a drawstring closure can be disposed along the perimeter of the flexible sheet of material to allow adjustable tensioning around the bumper.

In some embodiments, the flexible sheet of material has a thickness of between 0.5 mils and 20 mils depending on whether the cover is designed for disposable or reusable use. The flexible sheet of material can include a textured outer surface to enhance grip and stability when in contact with a loading dock. The flexible sheet of material can include an inner moisture-resistant or antimicrobial treatment to reduce contamination buildup.

An apparatus that is configured to be removable and replaceable is provided to allow for easy installation and removal from the bumper of the livestock trailer. The apparatus can be configured for single-use disposal after each loading or unloading operation to maintain biosecurity. Alternatively, the apparatus can be configured for multiple uses, and is cleanable using standard sanitation procedures.

In other embodiments, a method for helping to prevent contamination transfer between a livestock trailer bumper, a loading dock, a loading or unloading chute or any combination of these is disclosed. The method comprises of providing a protective cover comprising a flexible sheet of material and an elastic band secured along at least a portion of a perimeter of the flexible sheet of material. The method continues with stretching the elastic band over a rear bumper of a livestock trailer to secure the flexible sheet of material around the bumper. The method continues with positioning the livestock trailer at a loading dock such that the flexible sheet of material over the bumper contacts or comes into proximity with the dock. After use, the method continues with removing the protective cover from the bumper to prevent contamination transfer to another facility. The method can continue with disposing of the protective cover after a single use to maintain biosecurity. Alternatively, the method can continue with cleaning and sanitizing the protective cover after removal for subsequent reuse. In operation, the method includes installing a replacement protective cover before the livestock trailer backs up to another loading dock. The method can be carried out with the protective cover being installed and removed without requiring tools to facilitate quick application and removal.

### BRIEF DESCRIPTION OF THE DRAWINGS

These and other features and advantages of the present invention will be better understood by reading the following detailed description, taken together with the drawings wherein:

FIG. 1 is a perspective view of livestock trailer backing up to an unloading dock.

FIG. 2 is a perspective view of a protective cover over the bumper of a livestock trailer according to this disclosure.

FIG. 3 is a perspective view showing the installation of the protective cover of FIG. 2.

### DETAILED DESCRIPTION OF THE PREFERRED EMBODIMENTS

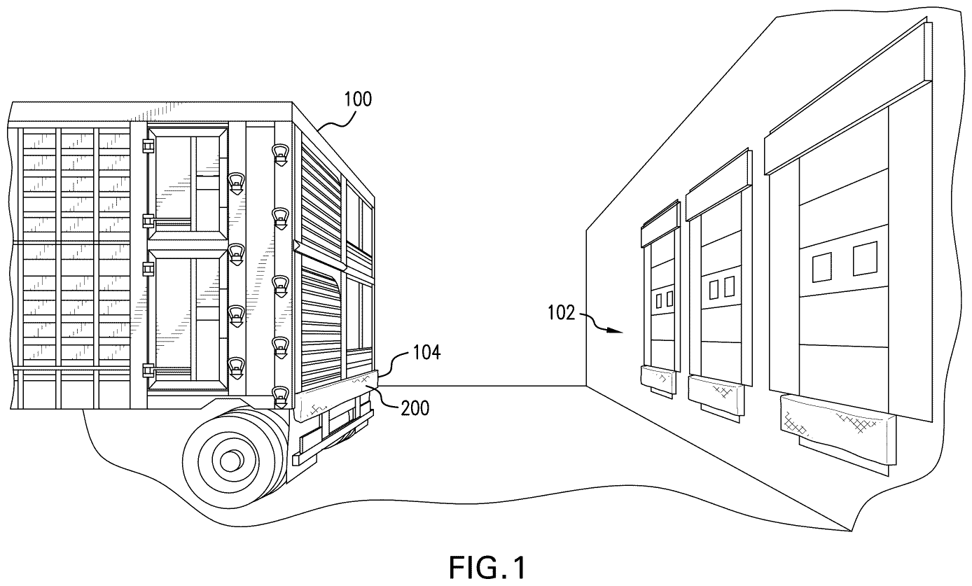

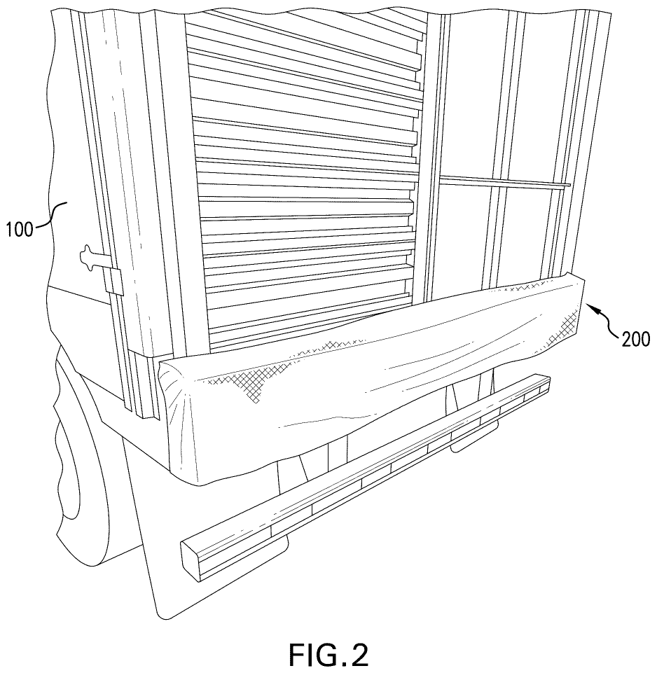

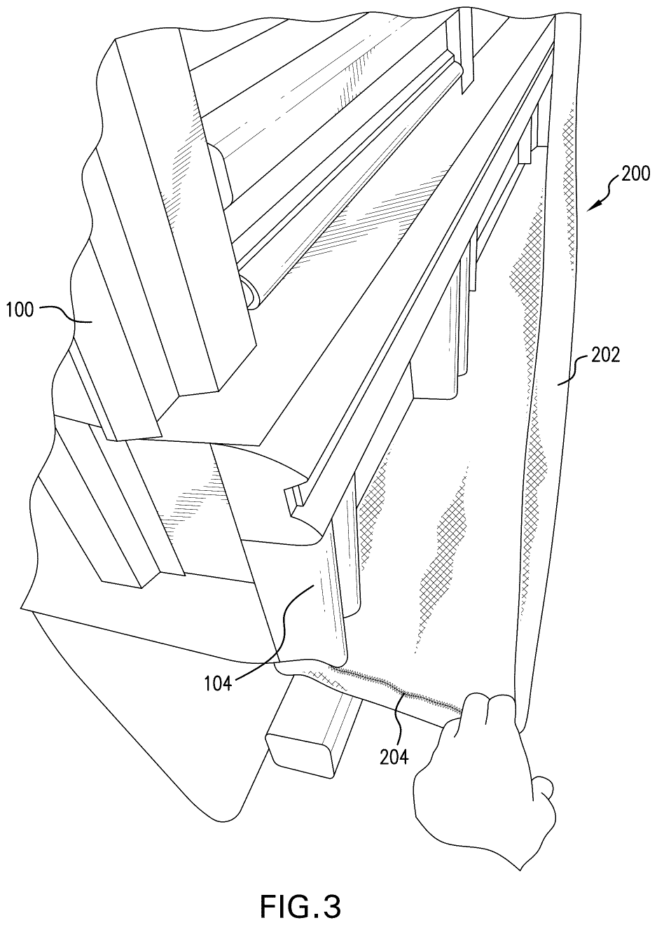

Referring now to the drawings, FIG. 1 illustrates a livestock trailer 100 backing up to a loading dock 102 for the purpose of loading or unloading livestock. As the trailer 100 moves into position, its rear bumper 104 comes into close proximity with or directly contacts the dock surface, creating a potential point of contamination transfer. To mitigate this risk, a protective cover 200, as shown in FIG. 2, is designed to fit securely over the bumper 104 to serve as a barrier against contaminants. The protective cover 200 comprises a flexible sheet of material 202 that is configured to wrap around the bumper 104 and is secured in place by an elastic band 204, ensuring a snug fit. FIG. 3 illustrates the process of installing the protective cover 200, wherein the elastic band 204 allows for easy placement and removal while maintaining a secure attachment to the bumper 104 during use.

The protective cover 200 is generally rectangular in shape, with dimensions selected to fully encase the exposed surfaces of the bumper 104. The cover 200 is designed to stretch over the bumper 104 and create a snug fit that prevents shifting or dislodgment during use. The edges of the cover 200 may be finished with a reinforced hem to improve durability and prevent fraying or tearing due to repeated installation and removal.

The flexible sheet of material 202 may be composed of various materials depending on the desired durability, contamination resistance, and reusability. Suitable materials for the sheet of material 202 include: Disposable plastic film, such as high-density polyethylene (HDPE) or low-density polyethylene (LDPE), which provides a lightweight, cost-effective, and single-use contamination barrier. Synthetic rubber or elastomeric material, such as thermoplastic elastomers (TPE) or silicone, which offers greater flexibility, resistance to tearing, and the ability to withstand repeated use and cleaning. Coated fabric materials, such as polyurethane-coated nylon or vinyl-coated polyester, which combine flexibility with resistance to moisture, chemical exposure, and abrasion. Nonwoven antimicrobial fabric, which provides an added layer of protection by incorporating antimicrobial treatments to inhibit bacterial or viral contamination.

The protective cover 200 is held in place by an elastic band 204 integrated into the perimeter of the cover. The elastic band 204 provides a secure and stretchable fit around the bumper 104, allowing for easy installation and removal while preventing slippage during use. The elastic band 204 may be encased within a fabric channel or directly bonded to the material 202 through heat sealing, stitching, or adhesive bonding. Alternative securing mechanisms may include: Hook-and-loop fasteners (e.g., Velcro®) for adjustable tension and ease of use. Drawstring closures for a customizable fit around bumpers of varying sizes. Snap fasteners or button closures for added security in high-movement environments.

The thickness of the sheet material 202 may vary depending on its intended use. For disposable applications, a thickness of approximately 0.5 to 2.0 mils (micrometers) may be sufficient. For reusable covers, a thickness of 5 to 20 mils may be used to ensure durability against repeated cleaning and wear.

The outer surface of protective cover 200 may include a textured or non-slip coating to enhance grip and stability when in contact with the loading dock 102. The inner surface of cover 200 may feature a moisture-resistant or antimicrobial treatment to further prevent contamination buildup. Cover 200 may be available in multiple sizes to accommodate different trailer bumper configurations.

Depending on the material selection, the protective cover 200 may be designed for single-use (disposable) or multiple uses with appropriate cleaning protocols. If reusable, the cover 200 should be cleaned and disinfected using standard sanitation procedures between uses to maintain biosecurity. Such procedures may include applying an EPA-approved or industry-recommended disinfectant that is effective against livestock-related pathogens such as PRRSV (Porcine Reproductive and Respiratory Syndrome Virus), PEDV (Porcine Epidemic Diarrhea Virus), and other bacteria or viruses, and ensuring full contact time as recommended by the disinfectant manufacturer to achieve proper pathogen elimination.

While the protective cover 200 is primarily designed for use over the bumper 104 of a livestock trailer 100 or the bumper of a loading dock 102, its utility extends to other surfaces and structures commonly encountered in livestock handling environments where contamination risks are prevalent. For instance, the cover 200 may be adapted for use on the side rails or edges of a loading or unloading chute, where livestock frequently make contact during transfer between trailers and holding pens, thereby reducing the spread of pathogens at these high-traffic points. Similarly, the cover 200 could be applied to the perimeter edges of sorting gates or alleyways within a livestock facility, providing a flexible barrier against contaminant accumulation on surfaces that animals brush against. In slaughterhouse or processing plant settings, the cover 200 might be fitted over conveyor rails or entryway bumpers that interface with transport vehicles, ensuring biosecurity across the supply chain. The adaptable design of the cover 200, with its flexible sheet 202 and elastic band 204 or alternative securing mechanisms, allows it to conform to various shapes and sizes of structural components, making it a versatile tool for maintaining hygiene in diverse livestock-related contexts.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. An apparatus for preventing contamination transfer between a livestock trailer bumper and a loading dock, the apparatus comprising:
a flexible sheet of material configured to wrap around and cover a rear bumper of a livestock trailer; and
an elastic band secured along at least a portion of a perimeter of the flexible sheet of material, the elastic band configured to stretch around the bumper to provide a snug and secure fit.

2. The apparatus of claim 1, wherein the flexible sheet of material is made from a disposable plastic film selected from the group consisting of high-density polyethylene (HDPE), low-density polyethylene (LDPE), and polypropylene.

3. The apparatus of claim 1, wherein the flexible sheet of material is made from a synthetic rubber or elastomeric material, including thermoplastic elastomers (TPE) or silicone.

4. The apparatus of claim 1, wherein the flexible sheet of material is made from a coated fabric material, including polyurethane-coated nylon or vinyl-coated polyester.

5. The apparatus of claim 1, wherein the flexible sheet of material is made from nonwoven antimicrobial fabric configured to inhibit bacterial or viral contamination.

6. The apparatus of claim 1, wherein the elastic band is enclosed within a hemmed perimeter of the flexible sheet of material.

7. The apparatus of claim 1, wherein the elastic band is heat-sealed, stitched, or adhesively bonded to the flexible sheet of material.

8. The apparatus of claim 1, further comprising hook-and-loop fasteners positioned on opposing edges of the flexible sheet of material to provide additional securement.

9. The apparatus of claim 1, further comprising a drawstring closure disposed along the perimeter of the flexible sheet of material to allow adjustable tensioning around the bumper.

10. The apparatus of claim 1, wherein the flexible sheet of material has a thickness of between 0.5 mils and 20 mils depending on whether the cover is designed for disposable or reusable use.

11. The apparatus of claim 1, wherein the flexible sheet of material includes a textured outer surface to enhance grip and stability when in contact with a loading dock.

12. The apparatus of claim 1, wherein the flexible sheet of material includes an inner moisture-resistant or antimicrobial treatment to reduce contamination buildup.

13. The apparatus of claim 1, wherein the apparatus is configured to be removable and replaceable, allowing for easy installation and removal from the bumper of the livestock trailer.

14. The apparatus of claim 1, wherein the apparatus is configured for single-use disposal after each loading or unloading operation to maintain biosecurity.

15. The apparatus of claim 1, wherein the apparatus is configured for multiple uses, and is cleanable using standard sanitation procedures.

16. A method for preventing contamination transfer between a livestock trailer bumper and a loading dock, the method comprising:
providing a protective cover comprising a flexible sheet of material and an elastic band secured along at least a portion of a perimeter of the flexible sheet of material;
stretching the elastic band over a rear bumper of a livestock trailer to secure the flexible sheet of material around the bumper;
positioning the livestock trailer at a loading dock such that the flexible sheet of material over the bumper contacts or comes into proximity with the dock; and
after use, removing the protective cover from the bumper to prevent contamination transfer to another facility.

17. The method of claim 16, further comprising disposing of the protective cover after a single use to maintain biosecurity.

18. The method of claim 16, further comprising cleaning and sanitizing the protective cover after removal for subsequent reuse.

19. The method of claim 16, further comprising installing a replacement protective cover before the livestock trailer backs up to another loading dock.

20. The method of claim 16, wherein the protective cover is installed and removed without requiring tools to facilitate quick application and removal.
